(19) United States
(12) Patent Application Publication
(10) Pub. No.: US 2012/0060987 A1
(43) Pub. Date: Mar. 15, 2012

(54) PNEUMATIC TIRE

(75) Inventor: Masayuki Nemoto, Hiratsuka-shi (JP)

(73) Assignee: THE YOKOHAMA RUBBER CO., LTD., Tokyo (JP)

(21) Appl. No.: 13/220,540

(22) Filed: Aug. 29, 2011

(30) Foreign Application Priority Data
Sep. 9, 2010 (JP) 2010-202417

(51) Int. Cl. B60C 11/117

(52) U.S. Cl. 152/209.8

(57) ABSTRACT

A pneumatic tire wherein a side from a tire ground contact center line having a smaller groove area ratio includes at least one circumferential main groove and at least one circumferential narrow groove. A depth of the circumferential narrow groove is not less than 60% and not more than 80% of a depth of the circumferential main groove closest to the tire ground contact center line. A width of the circumferential narrow groove is not less than 25% and not more than 40% of a width of the circumferential main groove closest to the tire ground contact center line. A distance from the tire ground contact center line to a center position in the tire width direction of the circumferential narrow groove is not less than 25% and not more than 35% of a tire ground contact width.

### PRIORITY CLAIM

Priority is claimed to Japan Patent Application Serial No. 2010-202417 filed on Sep. 9, 2010.

### BACKGROUND

1. Technical Field

The present technology relates to a pneumatic tire, and more particularly relates to a pneumatic tire whereby steering stability on dry road surfaces can be enhanced and durability can be enhanced.

2. Related Art

Conventionally, pneumatic tires having a designated tire mounting direction are known in which a first lateral groove is distanced from a circumferential narrow groove, and a land portion outward in the tire width direction of the circumferential narrow groove is formed into a rib. Additionally, the first lateral groove is formed by contiguously connecting a first arcuate groove portion, which is convex toward a first side in the tire circumferential direction, and a second arcuate groove portion, which is convex toward a second side in the tire circumferential direction (e.g. see Japanese Unexamined Patent Application Publication No. 2010-58781A). Thus, by separating the first lateral groove from the circumferential narrow groove, and forming the land portion outward in the tire width direction of the circumferential narrow groove into a rib, steering stability on dry road surfaces can be enhanced while suppressing a decline in steering stability on wet road surfaces.

In recent years, there has been a demand for further enhancements in steering stability of pneumatic tires in conjunction with a demand for higher vehicle performance. The pneumatic tire having the configuration described above is no exception and enhancements in steering stability are desired.

Additionally, with pneumatic tires having the configuration described above, there is a risk of abnormal wear and cracking occurring in the tread surface of an outer side of the tire when mounted on a vehicle after high-speed running or circuit running, and there is also a risk of durability declining.

### SUMMARY

The present technology provides a pneumatic tire in which steering stability on dry road surfaces and durability can be enhanced while a decline in steering stability on wet road surfaces is suppressed. A pneumatic tire (type 1) includes an asymmetrical pattern wherein groove area ratios with respect to a tread ground contact area in a first side in a tire width direction and in a second side in the tire width direction, demarcated by a tire ground contact center line, vary in a range of not less than 5% and not more than 15%. The side from the tire ground contact center line having a smaller groove area ratio includes at least one circumferential main groove and at least one circumferential narrow groove that is positioned on an outer side in the tire width direction of the circumferential main groove. A depth of the circumferential narrow groove is not less than 60% and not more than 80% of a depth of the circumferential main groove closest to the tire ground contact center line. A width of the circumferential narrow groove is not less than 25% and not more than 40% of a width of the circumferential main groove closest to the tire ground contact center line. A distance from the tire ground contact center line to a center position in the tire width direction of the circumferential narrow groove is not less than 25% and not more than 35% of a tire ground contact width.

This pneumatic tire includes an asymmetrical pattern wherein groove area ratios with respect to a tread ground contact area in a first side in a tire width direction and in a second side in the tire width direction, demarcated by a tire ground contact center line, vary in a range of not less than 5% and not more than 15%. This configuration is used primarily for the purpose of providing more land portions on the outer side of the tire when mounted on a vehicle, which is subjected to a relatively greater amount of wear when high-speed running or circuit running, thus relatively increasing the stiffness of the outer side of the tire when mounted on a vehicle.

Additionally, with this pneumatic tire, the side from the tire ground contact center line having a smaller groove area ratio (the outer side of the tire when mounted on a vehicle) includes at least one circumferential main groove and at least one circumferential narrow groove that is positioned on an outer side in the tire width direction of the circumferential main groove. Moreover, in this pneumatic tire, a depth of the circumferential narrow groove is not less than 60% and not more than 80% of a depth of the circumferential main groove closest to the tire ground contact center line.

By configuring the depth of the circumferential narrow groove to be not less than 60% of the depth of the circumferential main groove closest to the tire ground contact center line, water removal performance can be sufficiently ensured, and a decline in steering stability on wet road surfaces can be suppressed. Additionally, by configuring the depth of the circumferential narrow groove to be not more than 80% of the depth of the circumferential main groove closest to the tire ground contact center line, rigidity of the land portions positioned on both sides of the circumferential narrow groove in the tire width direction can be sufficiently ensured. As a result, notching of the land portion edges and abnormal wear of the land portions can be suppressed, and steering stability on dry road surfaces can be enhanced.

Furthermore, in this pneumatic tire, a width of the circumferential narrow groove is not less than 25% and not more than 40% of a width of the circumferential main groove closest to the tire ground contact center line. By configuring the width of the circumferential narrow groove to be not less than 25% of the width of the circumferential main groove closest to the tire ground contact center line, water removal performance can be sufficiently ensured, and a decline in steering stability on wet road surfaces can be suppressed. Additionally, by configuring the width of the circumferential narrow groove to be not more than 40% of the width of the circumferential main groove closest to the tire ground contact center line, rigidity of the land portions positioned on both sides of the circumferential narrow groove in the tire width direction can be sufficiently ensured. As a result, notching of the land portion edges and abnormal wear of the land portions can be suppressed, and steering stability on dry road surfaces can be enhanced.

Additionally, in this pneumatic tire, a distance from the tire ground contact center line to a center position in the tire width direction of the circumferential narrow groove is not less than 25% and not more than 35% of a tire ground contact width. By configuring the distance from the tire ground contact center line to a center position in the tire width direction of the circumferential narrow groove to be not less than 25%, the rigidity of the land portion adjacent to the circumferential narrow groove on the inner side in the tire width direction can be sufficiently ensured, and steering stability on dry road surfaces under high severity conditions can be enhanced. Moreover, by configuring the distance from the tire ground contact center line to a center position in the tire width direction of the circumferential narrow groove to be not more than 35%, a reduction in groove cubic capacity caused by deformation of the circumferential narrow groove when the circumferential narrow groove contacts the ground can be suppressed, the width of the circumferential narrow groove can be sufficiently ensured, a decline in steering stability on wet road surfaces can be suppressed and uneven wear caused by repeated deformation can be suppressed.

As described above, by appropriately configuring the asymmetrical pattern demarcated by the tire ground contact center line, the depth and the width of the circumferential narrow groove with respect to the depth and the width of a specific circumferential main groove, and the position of the circumferential narrow groove with respect to the tire ground contact center line, the pneumatic tire (type 1) of the present technology can particularly enhance steering stability on dry road surfaces, while ensuring sufficient water removal performance and suppressing a decline in steering stability on wet road surfaces. Additionally, as described above, according to the pneumatic tire (type 1) of the present technology rigidity of the land portions of the tread surface can be sufficiently ensured and notching of the land portion edges and abnormal wear of the land portions can be suppressed. However, this does not lead to only steering stability on dry road surfaces being enhanced, but also to the enhancing of the durability of the pneumatic tire (type 1).

Furthermore, in order to resolve the problems described above and achieve the object, a pneumatic tire (type 2) of the present technology includes an asymmetrical pattern wherein groove area ratios with respect to a tread ground contact area in a first side in a tire width direction and in a second side in the tire width direction, demarcated by a tire ground contact center line, vary in a range of not less than 5% and not more than 15%. The side from the tire ground contact center line having a smaller groove area ratio includes at least one circumferential main groove and at least one circumferential narrow groove that is positioned on an outer side in the tire width direction of the circumferential main groove. A depth of the circumferential narrow groove is not less than 60% and not more than 80% of a depth of the circumferential main groove positioned on the tire ground contact center line. A width of the circumferential narrow groove is not less than 25% and not more than 40% of a width of the circumferential main groove positioned on the tire ground contact center line. A distance from the tire ground contact center line to a center position in the tire width direction of the circumferential narrow groove is not less than 25% and not more than 35% of a tire ground contact width.

As with the pneumatic tire (type 1) described above, by appropriately configuring the asymmetrical pattern demarcated by the tire ground contact center line, the depth and the width of the circumferential narrow groove with respect to the depth and the width of a specific circumferential main groove, and the position of the circumferential narrow groove with respect to the tire ground contact center line, this pneumatic tire (type 2) can particularly enhance steering stability on dry road surfaces while ensuring sufficient water removal performance and suppressing a decline in steering stability on wet road surfaces. Additionally, as described above, according to the pneumatic tire (type 2) of the present technology rigidity of the land portions of the tread surface can be sufficiently ensured and notching of the land portion edges and abnormal wear of the land portions can be suppressed. However, this does not lead to only steering stability on dry road surfaces being enhanced, but also to the enhancing of the durability of the pneumatic tire (type 2).

In the pneumatic tire (type 1) of the present technology, one circumferential main groove is provided and one circumferential narrow groove is provided.

Additionally, in the pneumatic tires of the present technology (type 1 and type 2), a tread gauge on an inner side in a tire radial direction of the circumferential narrow groove is preferably not less than 1.3 times and not more than 2.6 times greater than a tread gauge on the inner side in the tire radial direction of the circumferential main groove closest to the tire ground contact center line, or a tread gauge on the inner side in the tire radial direction of the circumferential main groove positioned on the tire ground contact center line. By configuring the tread gauge of the inner side in the tire radial direction of the circumferential narrow groove so as to be within such a given range, ground contact pressure from the circumferential main groove closest to the tire ground contact center line or the circumferential main groove positioned on the tire ground contact center line to the circumferential narrow groove can be made constant. As a result, notching of the land portion edges and abnormal wear of the land portions can be efficiently suppressed, and steering stability on dry road surfaces can be efficiently enhanced.

Additionally, in the pneumatic tires of the present technology (type 1 and type 2), the circumferential main groove having a center position in the tire width direction on the side from the tire ground contact center line with the smaller groove area ratio preferably has a distance from the tire ground contact center line to the center position of the circumferential main groove that is not less than 10% and not more than 20% of the tire ground contact width. By configuring the distance from the tire ground contact center line to a center position of a specific circumferential main groove to be not less than 10%, optimum rigidity of the land portion that includes the tire ground contact center line can be sufficiently ensured, and steering stability on dry road surfaces under high severity conditions can be ensured. By configuring the distance from the tire ground contact center line to a center position of a specific circumferential main groove to be not more than 20%, this configuration will work in concert with the range setting of the distance from the tire ground contact center line to the center position of the circumferential narrow groove described above. As a result, the rigidity of the land portion adjacent to the circumferential narrow groove on the inner side in the tire width direction can be further ensured and steering stability on dry road surfaces under high severity conditions can be further enhanced.

Additionally by configuring the distance from the tire ground contact center line to the center position of the circumferential main groove to be not less than 10% and not more than 20% of the tire ground contact width, this configuration will work in concert with the range setting of the distance from the tire ground contact center line to the center position of the circumferential narrow groove described above. Therefore, an optimum land portion adjacent to the circumferential narrow groove on the inner side in the tire width direction that meets the tire nominal width (defined by the Japan Automobile Tyre Manufacturers Association Inc. (JATMA)) and desired tire performance can be obtained. As a result, notching of the land portion edges and abnormal wear of the land portions can be further suppressed, and steering stability on dry road surfaces can be further enhanced.

Moreover, in the pneumatic tires (type 1 and type 2) of the present technology, a smallest cross-sectional area of the circumferential narrow groove is preferably not less than 20% and not more than 30% of a smallest cross-sectional area of the circumferential main groove closest to the tire ground contact center line or a smallest cross-sectional area of the circumferential main groove positioned on the tire ground contact center line. By configuring the smallest cross-sectional area of the circumferential narrow groove to be not less than 20% of the smallest cross-sectional area of the circumferential main groove closest to the tire ground contact center line or the circumferential main groove positioned on the tire ground contact center line, the groove cubic capacity of the outer side in the tire width direction of the tread contact patch can be sufficiently ensured. As a result, water removal performance can be further ensured, and a decline in steering stability on wet road surfaces can be further suppressed. By configuring the smallest cross-sectional area of the circumferential narrow groove to be not more than 30% of the smallest cross-sectional area of the circumferential main groove closest to the tire ground contact center line or the circumferential main groove positioned on the tire ground contact center line, the rigidity of the land portion positioned on both sides of the circumferential narrow groove in the tire width direction can be further ensured. As a result, notching of the land portion edges and abnormal wear of the land portions can be further suppressed, and steering stability on dry road surfaces can be further enhanced.

Additionally, in the pneumatic tires (type 1 and type 2) of the present technology, a JIS A hardness of a rubber material constituting a tread portion on the side from the tire ground contact center line having the smaller groove area ratio is preferably not less than 71 and not more than 77. By configuring the JIS A hardness of the rubber material to be not less than 71, the amount of deformation of the tread portion can be suppressed. As a result, various effects due to the stipulations of the positions and depths of the circumferential narrow groove and the circumferential main groove described above can be realized, particularly, suppression of the decline in the steering stability on wet road surfaces and enhancement of the steering stability on dry road surfaces can be sufficiently realized. By configuring the JIS A hardness of the rubber material to be not more than 77, steering stability and riding comfort can both be obtained.

Moreover, in the pneumatic tires (type 1 and type 2) of the present technology, a tire nominal width (defined by JATMA) is preferably not less than 265. As the tire nominal width increases, the width of the circumferential main groove and the width of the circumferential narrow groove also increase. By configuring the tire nominal width to be not less than 265, this configuration will work in concert with the range setting of the positions and the depths of the circumferential narrow groove and the circumferential main groove described above. As a result, particularly, suppression of the decline in the steering stability on wet road surfaces and enhancement of the steering stability on dry road surfaces can be sufficiently realized.

According to the present technology a pneumatic tire can be provided in which steering stability on dry road surfaces and durability can be enhanced while a decline in steering stability on wet road surfaces is suppressed.

### BRIEF DESCRIPTION OF THE DRAWINGS

FIG. 1 is a plan view illustrating a tread surface of a pneumatic tire of embodiment 1.

FIG. 2 is a meridian cross-sectional view illustrating a tread portion of the pneumatic tire of embodiment 1.

FIG. 3 is a meridian cross-sectional view illustrating an enlargement of a region a depicted in FIG. 2.

FIG. 4 is a plan view illustrating a tread surface of a pneumatic tire of embodiment 2.

FIG. 5 is a meridian cross-sectional view illustrating a tread portion of the pneumatic tire of embodiment 2.

FIG. 6 is a meridian cross-sectional view illustrating an enlargement of a region B depicted in FIG. 5.

FIG. 7 is a table showing results of performance testing of pneumatic tires according to examples of the present technology.

FIG. 8 is a table showing results of performance testing of pneumatic tires according to examples of the present technology.

### DETAILED DESCRIPTION

The present technology is described in detail below with reference to the drawings. However, the present technology is not limited by this description. Furthermore, the constituents described below include those constituents that could be easily conceived by a person skilled in the art, and constituents that are essentially identical, or, in other words, that have an equivalent scope. Additionally, the configurations described below can be combined as desired.

In the following description, “tire width direction” refers to a direction that is parallel with a rotational axis of a pneumatic tire; “outer side in the tire width direction” refers to a side distanced from a tire equatorial plane in the tire width direction; and “inner side in the tire width direction” refers to a side near the tire equatorial plane in the tire width direction. “Tire circumferential direction” refers to a direction of rotation with the rotational axis as the center axis. “Tire radial direction” refers to a direction orthogonal to the rotational axis”; “outer side in the tire radial direction” refers to a side distanced from the rotational axis in the tire radial direction; and “inner side in the tire radial direction” refers to a side near the rotational axis in the tire radial direction.

### Embodiment 1

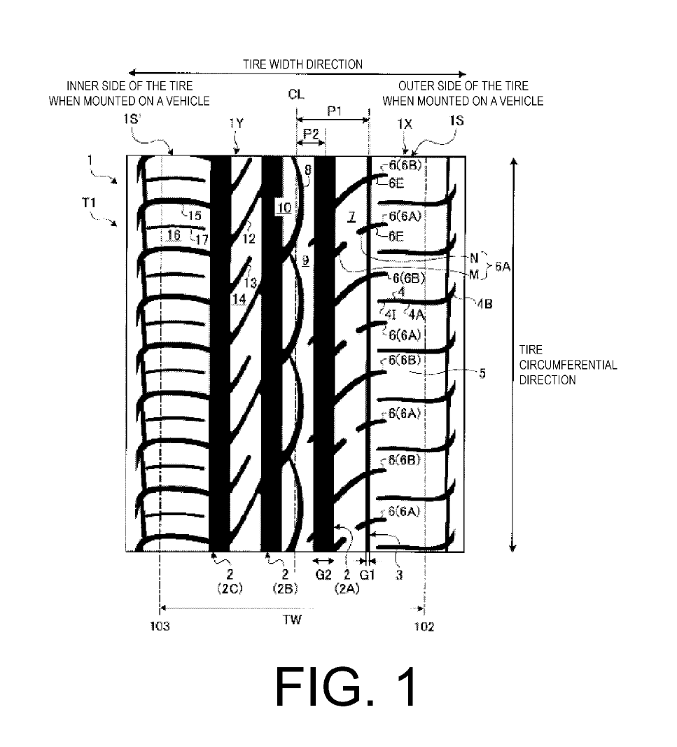

FIG. 1 is a plan view illustrating a tread surface of a pneumatic tire of embodiment 1. A pneumatic tire T1 illustrated in FIG. 1 has a designated mounting direction when mounted on a vehicle, and is configured so that the side right of a tire ground contact center line CL is the outer side of the tire when mounted on a vehicle. Here, “tire ground contact center line CL” refers to a center line in the tire width direction in a tread contact patch when the pneumatic tire T1 is assembled on a regular rim, inflated to a regular pressure, and when loaded with a designated load. “Regular rim” refers to a “standard rim” defined by JATMA, a “Design Rim” defined by the Tire and Rim Association, Inc. (TRA), or a “Measuring Rim” defined by the European Tyre and Rim Technical Organisation (ETRTO). “Regular inner pressure” refers to the “maximum air pressure” defined by JATMA, the maximum value in “tire load limits at various cold inflation pressures” defined by TRA, and the “inflation pressures” defined by ETRTO. “Designated load” refers to the “load capacity when inflated to maximum air pressure” defined by JATMA, the “load capacity when inflated to maximum air pressure” defined by TRA, or the “load capacity when inflated to maximum air pressure” defined by ETRTO.

In the pneumatic tire T1 illustrated in FIG. 1, three circumferential main grooves 2 extending linearly in the tire circumferential direction are provided in a tread surface 1. The tread surface 1 includes an outer side region 1X positioned outward of the tire ground contact center line CL when the tire is mounted, and an inner side region 1Y positioned inward of the tire ground contact center line CL when the tire is mounted.

The three circumferential main grooves 2 include one first circumferential main groove 2A disposed in the outer side region 1X and two circumferential main grooves 2B and 2C disposed in the inner side region 1Y. The two circumferential main grooves 2B and 2C are a second circumferential main groove 2B positioned on the tire ground contact center line CL side and a third circumferential main groove 2C positioned toward the outer side in the tire width direction separated from the second circumferential main groove 2B.

One circumferential narrow groove 3 is disposed toward the outer side in the tire width direction from the first circumferential main groove 2A. The circumferential narrow groove 3 extends linearly in the tire circumferential direction and has a groove width (from 5 to 7 mm) that is less than that of the first circumferential main groove 2A. The outer side in the tire width direction from the circumferential narrow groove 3 is a shoulder region 1S of the tread surface 1. A first lateral groove 4, extending beyond a first tire ground contact edge 102 in the tire width direction, is provided in the shoulder region 1S with a predetermined spacing in the tire circumferential direction.

The first lateral groove 4 is separated from the circumferential narrow groove 3 so as not to be in communication, and a land portion farther toward the outer side in the tire width direction than the circumferential narrow groove 3 is formed into a rib 5 that is continuous in the tire circumferential direction. Additionally, the first lateral groove 4 has an “S” shape structure in which a first arcuate groove portion 4A, which is convex toward a first side in the tire circumferential direction, and a second arcuate groove portion 4B, which is convex toward a second side in the tire circumferential direction are contiguously connected.

A second lateral groove 6 extending beyond the circumferential narrow groove 3 from the first circumferential main groove 2A toward the outer side in the tire width direction is disposed with a predetermined spacing in the tire circumferential direction. The second lateral groove 6 that extends inclined with respect to the tire width direction is disposed offset in the tire circumferential direction with respect to the first lateral groove 4 so that a portion extending beyond the circumferential narrow groove 3 does not intersect with the first lateral groove 4. An outer side end 6E of the second lateral groove 6 extends so as to overlap with an inner side end 41 of the first lateral groove 4, when viewed in the tire circumferential direction.

A second lateral groove 6A disposed alternately in the tire circumferential direction is constituted by a lateral groove portion M that extends from the first circumferential main groove 2A to a portion partway between the circumferential narrow groove 3 and the first circumferential main groove 2A, and a lateral groove portion N that extends from a position separated from the lateral groove portion M to beyond the circumferential narrow groove 3. A remaining alternately disposed second lateral groove 6B extends from the first circumferential main groove 2A to a position beyond the circumferential narrow groove 3. A block 7 is formed, partitioned by adjacent second lateral grooves 6B, between the first circumferential main groove 2A and the circumferential narrow groove 3. As illustrated in FIG. 1, by forming the block 7 so as to be long in the tire circumferential direction with respect to the tire width direction, rigidity in the tire circumferential direction is increased and steering stability on dry road surfaces is enhanced.

A plurality of sub grooves 8, extending in an arcuate manner in the tire circumferential direction from the second circumferential main groove 2B to beyond the tire ground contact center line CL, is disposed so that a portion thereof overlaps. One rib 9 is partitioned and formed by the plurality of sub grooves 8 and the first circumferential main groove 2A between the first circumferential main groove 2A and the second circumferential main groove 2B. Additionally, a block 10 is partitioned and formed by the plurality of sub grooves 8 and the second circumferential main groove 2B between the first circumferential main groove 2A and the second circumferential main groove 2B.

A third lateral groove 12 extending inclined with respect to the tire width direction and communicating with both the circumferential main grooves 2B and 2C, and a fourth lateral groove 13 extending inclined with respect to the tire width direction from the third circumferential main groove 2C to a portion partway through a block 14 (described hereinafter) are alternately disposed with a predetermined spacing in the tire circumferential direction between the second circumferential main groove 2B and the third circumferential main groove 2C of the inner side region 1Y. The block 14 is partitioned and formed by the third lateral groove 12 and the circumferential main grooves 2B and 2C.

A fifth lateral groove 15, extending from the third circumferential main groove 2C to beyond a second tire ground contact edge 103 toward the outer side in the tire width direction, is disposed with a predetermined spacing in the tire circumferential direction in a shoulder region 1S′ of the inner side region 1Y that is outward of the third circumferential main groove 2C in the tire width direction. A block 16 is partitioned and formed by the third circumferential main groove 2C and the fifth lateral groove 15. One sipe 17 extending in the tire width direction is provided in each of the blocks 16.

Based on such a structure, the pneumatic tire T1 is configured as described below. First, the tread surface 1 has an asymmetrical pattern demarcated by the tire ground contact center line CL, wherein groove area ratios in a first side in a tire width direction and a second side in the tire width direction vary in a range of not less than 5% and not more than 15%. The example illustrated in FIG. 1 is an asymmetrical pattern wherein the groove area ratio of the outer side of the tire when mounted on a vehicle is 6% less compared to that of the inner side of the tire when mounted on a vehicle.

Here, “groove area ratio” refers to a ratio of the groove area with respect to the tread ground contact area when the pneumatic tire T1 is assembled on a regular rim, inflated to a regular pressure, and when loaded with a designated load. The “groove area ratio in the first side in the tire width direction” and the “groove area ratio in the second side in the tire width direction” refer to ratios of the groove area with respect to the tread ground contact area within ranges through to the ground contact edges 102 and 103 of the outer side of the tire when mounted on a vehicle and the inner side of the tire when mounted on a vehicle, respectively, demarcated by the tire ground contact center line CL.

By varying the groove area ratios in the first side in the tire width direction and the second side in the tire width direction, demarcated by the tire ground contact center line CL, by not less than 5%, more land portions can be provided on the outer side of the tire when mounted on a vehicle which is a portion of the tread surface 1 subjected to a relatively greater amount of wear when high-speed running or circuit running. As a result, the rigidity on the outer side of the tire when mounted on a vehicle can be made relatively greater, and a degree of rigidity sufficient for realizing the desired steering stability can be continuously ensured though a small amount of wear. Therefore, it is possible to enhance steering stability on dry road surfaces. Additionally, by varying the groove area ratios with respect to the tread ground contact area in the first side in the tire width direction and the second side in the tire width direction, demarcated by the tire ground contact center line CL, by not more than 15%, uneven wear on the outer side of the vehicle and the inner side of the vehicle can be evened out. Therefore, both steering stability and durability can be obtained.

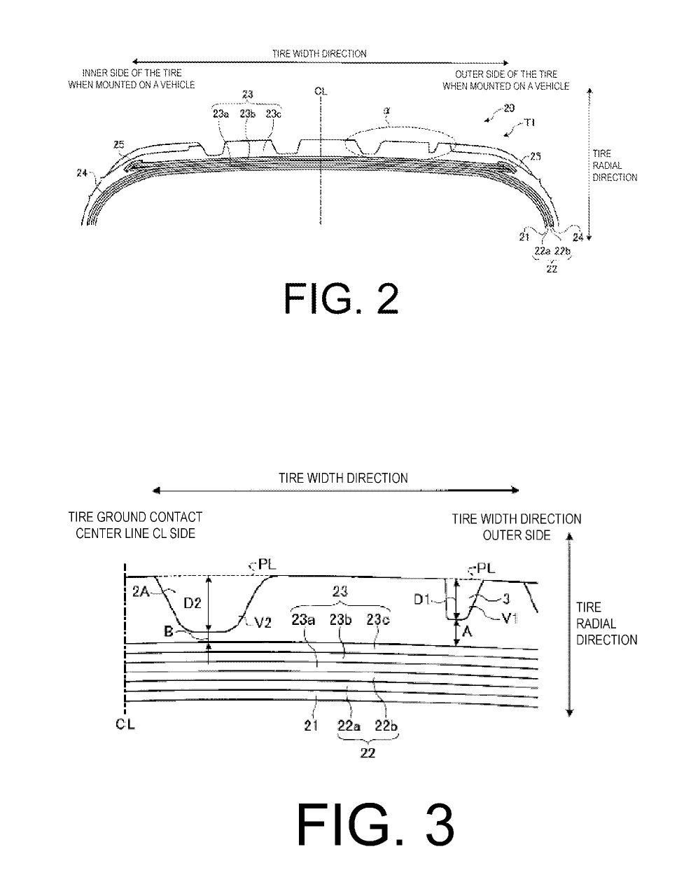

FIG. 2 is a meridian cross-sectional view illustrating a tread portion of the pneumatic tire of embodiment 1. The pneumatic tire T1 illustrated in FIG. 2 includes an inner liner 21, a carcass layer 22 formed from two layers of carcass 22a and 22b disposed subsequently on an outer side in the tire radial direction of the inner liner 21, and a belt layer 23 formed from three layers of belts 23a, 23b, and 23c disposed subsequently on an outer side in the tire radial direction of the carcass layer 22. Additionally, a first reinforcing layer 24 is formed on an outer side in the tire radial direction of a curved portion of the carcass layer 22, and a second reinforcing layer 25 is formed on an outer side in the tire radial direction of both ends of the belt layer 23. Note that in FIG. 2, the tread portion is indicated by reference numeral 20.

FIG. 3 is a meridian cross-sectional view illustrating an enlargement of a region a depicted in FIG. 2. As illustrated in FIG. 3, with the pneumatic tire T1 of embodiment 1, one first circumferential main groove 2A and one circumferential narrow groove 3 positioned on the outer side in the tire width direction of the first circumferential main groove 2A are formed in the side from the tire ground contact center line CL having the smaller groove area ratio (the outer side of the tire when mounted on a vehicle). Additionally, a depth D1 of the circumferential narrow groove 3 is configured to be not less than 60% and not more than 80% of a depth D2 of the first circumferential main groove 2A closest to the tire ground contact center line CL.

The groove depth D1 of the circumferential narrow groove 3 and the groove depth D2 of the first circumferential main groove 2A each refer to distances measured on a normal line drawn from a tire profile line PL, from the profile line PL to a groove bottom.

By configuring the depth D1 of the circumferential narrow groove 3 to be not less than 60% of the depth D2 of the first circumferential main groove 2A closest to the tire ground contact center line CL, water removal performance can be sufficiently ensured. As a result, it is possible to suppress the decline in steering stability on wet road surfaces. Moreover, by configuring the depth D1 of the circumferential narrow groove 3 to be not more than 80% of the depth D2 of the first circumferential main groove 2A closest to the tire ground contact center line CL, rigidity of the land portions positioned on both sides of the circumferential narrow groove 3 in the tire width direction can be sufficiently ensured. As a result, notching of the land portion edges and abnormal wear of the land portions can be suppressed, and steering stability on dry road surfaces can be enhanced.

By configuring this range of the depth D1 of the circumferential narrow groove 3 to be not less than 65% and not more than 75% of the depth D2 of the first circumferential main groove 2A, the suppression of the decline in steering stability on wet road surfaces and the enhancing of steering stability on dry road surfaces can be realized at a higher level.

Additionally, as illustrated in FIG. 1, with the pneumatic tire T1 of embodiment 1, a width G1 of the circumferential narrow groove 3 is configured so as to be not less than 25% and not more than 40% of a width G2 of the first circumferential main groove 2A closest to the tire ground contact center line.

By configuring the width G1 of the circumferential narrow groove 3 to be not less than 25% of the width G2 of the first circumferential main groove 2A closest to the tire ground contact center line CL, water removal performance can be sufficiently ensured. As a result, it is possible to suppress the decline in steering stability on wet road surfaces. Moreover, by configuring the width G1 of the circumferential narrow groove 3 to be not more than 40% of the width G2 of the first circumferential main groove 2A closest to the tire ground contact center line CL, rigidity of the land portions positioned on both sides of the circumferential narrow groove 3 in the tire width direction can be sufficiently ensured. As a result, notching of the land portion edges and abnormal wear of the land portions can be suppressed, and steering stability on dry road surfaces can be enhanced.

Additionally, as illustrated in FIG. 1, with the pneumatic tire T1 of embodiment 1, a distance P1 from the tire ground contact center line CL to the center position in the tire width direction of the circumferential narrow groove 3 is configured to be not less than 25% and not more than 35% of a tire ground contact width TW. The “tire ground contact width TW”, for example, as specified in JATMA Year Book 2009 edition, refers to a maximum linear distance in the tire axial direction of a contact surface with a flat plate when a tire is assembled on an application rim (regular rim), inflated to a given air pressure (regular internal pressure), placed so as to be perpendicular to a flat plane in a static state, and loaded with a load (designated load) corresponding with a given mass. For example, “ground contact width of a pneumatic tire having a tire size of 275/45R20 110Y” refers to a maximum linear distance in the tire axial direction of a contact surface with a flat plate when a tire is assembled on a rim having a rim size of 20×9J, inflated to an air pressure of 260 kPa, and loaded with a load of 6.5 kN.

By configuring the distance P1 from the tire ground contact center line CL to a center position in the tire width direction of the circumferential narrow groove 3 to be not less than 25% of the tire ground contact width TW, the rigidity of the land portion adjacent to the circumferential narrow groove 3 on the inner side in the tire width direction can be sufficiently ensured. As a result, steering stability on dry road surfaces under high severity conditions can be enhanced. Moreover, by configuring the distance P1 from the tire ground contact center line CL to a center position in the tire width direction of the circumferential narrow groove 3 to be not more than 35% of the tire ground contact width TW, a reduction in groove cubic capacity caused by deformation of the circumferential narrow groove 3 when the circumferential narrow groove 3 contacts the ground can be suppressed and the width G1 of the circumferential narrow groove 3 can be sufficiently ensured. As a result, a decline in steering stability on wet road surfaces can be suppressed, and uneven wear caused by repeated deformation can be suppressed.

As described above, the pneumatic tire T1 of embodiment 1 is formed by appropriately configuring the asymmetrical pattern demarcated by the tire ground contact center line CL, the depth and the width of the specific circumferential narrow groove 3 with respect to the depth and the width of the specific first circumferential main groove 2A, and the position of the circumferential narrow groove 3 with respect to the tire ground contact center line CL. With such a configuration, steering stability on dry road surfaces can be particularly enhanced while sufficient water removal performance is ensured and a decline in steering stability on wet road surfaces is suppressed. Additionally, according to the pneumatic tire T1 of embodiment 1, rigidity of the land portions of the tread surface 1 can be sufficiently ensured and notching of the land portion edges and abnormal wear of the land portions can be suppressed. However, this does not lead to only steering stability on dry road surfaces being enhanced, but also to the enhancing of the durability of the pneumatic tire T1.

As illustrated in FIG. 1, the pneumatic tire T1 of this embodiment can be configured so that one of the circumferential main grooves 2 and one circumferential narrow groove 3 are provided in the side, demarcated by the tire ground contact center line CL, from the tire ground contact center line CL having the smaller groove area ratio.

Additionally, as illustrated in FIG. 3, with the pneumatic tire T1 of this embodiment, a tread gauge A on the inner side in the tire radial direction of the circumferential narrow groove 3 is preferably not less than 1.3 times and not more than 2.6 times greater than a tread gauge B on the inner side in the tire radial direction of the first circumferential main groove 2A closest to the tire ground contact center line CL.

Here, the “tread gauge A on the inner side in the tire radial direction of the circumferential narrow groove 3” and the “tread gauge B on the inner side in the tire radial direction of the first circumferential main groove 2A” each refer to depths from a member other than a rubber material member, for example, the belt cords constituting the belt layer 23, to the groove bottom; and specifically refers to the shortest distance between the member closest to the groove bottom and the groove bottom.

By configuring the tread gauge A on the inner side in the tire radial direction of the circumferential narrow groove 3 so as to be within such a given range, ground contact pressure from the first circumferential main groove 2A closest to the tire ground contact center line CL to the circumferential narrow groove 3 can be made constant. As a result, notching of the land portion edges and abnormal wear of the land portions can be efficiently suppressed, and steering stability on dry road surfaces can be efficiently enhanced.

Additionally, as illustrated in FIG. 1, with the pneumatic tire T1 of this embodiment, regarding the first circumferential main groove 2A, a distance P2 from the tire ground contact center line CL to the center position of the first circumferential main groove 2A is preferably not less than 10% and not more than 20% of the tire ground contact width TW. By configuring the distance from the tire ground contact center line CL to the center position of the specific first circumferential main groove 2A to be not less than 10% of the tire ground contact width TW, optimum rigidity of the land portion that includes the tire ground contact center line can be sufficiently ensured, and steering stability on dry road surfaces under high severity conditions can be ensured. By configuring the distance from the tire ground contact center line CL to the center position of the specific first circumferential main groove 2A to be not more than 20% of the tire ground contact width TW, this configuration will work in concert with the range setting of the distance P1 from the tire ground contact center line CL to the center position of the circumferential narrow groove 3 described above. As a result, the rigidity of the block 7 adjacent to the circumferential narrow groove 3 on the inner side in the tire width direction can be further ensured. As a result, steering stability on dry road surfaces under high severity conditions can be further enhanced.

Additionally by configuring the distance P2 from the tire ground contact center line CL to the center position of the specific first circumferential main groove 2A to be not less than 10% and not more than 20% of the tire ground contact width TW, this configuration will work in concert with the range setting of the distance P1 from the tire ground contact center line CL to the center position of the circumferential narrow groove 3 described above. Therefore, an optimum block 7 adjacent to the circumferential narrow groove 3 on the inner side in the tire width direction that meets the tire nominal width (defined by JATMA) and desired tire performance can be obtained. As a result, notching of the land portion edges and abnormal wear of the land portions can be further suppressed, and steering stability on dry road surfaces can be further enhanced.

Additionally, as illustrated in FIG. 3, with the pneumatic tire T1 of this embodiment, a smallest cross-sectional area V1 of the circumferential narrow groove 3 is preferably not less than 20% and not more than 30% of a smallest cross-sectional area V2 of the first circumferential main groove 2A closest to the tire ground contact center line CL. As illustrated in FIG. 3, the smallest cross-sectional area V1 of the circumferential narrow groove 3 and the smallest cross-sectional area V2 of the first circumferential main groove 2A are, in a meridian cross-sectional view, each an area surrounded by the tire profile line PL and the groove walls.

By configuring the smallest cross-sectional area V1 of the circumferential narrow groove 3 to be not less than 20% of the smallest cross-sectional area V2 of the first circumferential main groove 2A closest to the tire ground contact center line CL, the groove cubic capacity of the outer side in the tire width direction of the tread contact patch can be sufficiently ensured. As a result, water removal performance can be further ensured, and a decline in steering stability on wet road surfaces can be further suppressed. By configuring the smallest cross-sectional area V1 of the circumferential narrow groove 3 to be not more than 30% of the smallest cross-sectional area V2 of the first circumferential main groove 2A closest to the tire ground contact center line CL, the rigidity of the rib 5 and the block 7 positioned on both sides of the circumferential narrow groove 3 in the tire width direction can be further ensured. As a result, notching of the land portion edges and abnormal wear of the land portions can be further suppressed, and steering stability on dry road surfaces can be further enhanced.

Additionally, with the pneumatic tire T1 of this embodiment, a JIS A hardness of a rubber material constituting the tread portion on the side from the tire ground contact center line CL having the smaller groove area ratio is preferably not less than 71 and not more than 77. By configuring the JIS A hardness of the rubber material to be not less than 71, the amount of deformation of the tread portion can be suppressed. As a result, various effects due to the stipulations of the positions and depths of the circumferential narrow groove 3 and the first circumferential main groove 2A described above can be realized, particularly, suppression of the decline in the steering stability on wet road surfaces and enhancement of the steering stability on dry road surfaces can be sufficiently realized. Additionally, by configuring the JIS A hardness of the rubber material to be not more than 77, steering stability and riding comfort can both be obtained.

Additionally, with the pneumatic tire T1 of this embodiment, the tire nominal width which is defined by JATMA is preferably not less than 265. As the tire nominal width increases, the width G2 of the first circumferential main groove 2A and the width G1 of the circumferential narrow groove 3 also increase. By configuring the tire nominal width to be not less than 265, this configuration will work in concert with the range setting of the positions and the depths of the circumferential narrow groove 3 and the first circumferential main groove 2A, such as those described above. As a result, particularly, suppression of the decline in the steering stability on wet road surfaces and enhancement of the steering stability on dry road surfaces can be sufficiently realized.

### Embodiment 2

Next, a description of Embodiment 2 will be given. Embodiment 2 differs from Embodiment 1 in that a circumferential main groove is positioned on the tire ground contact center line CL.

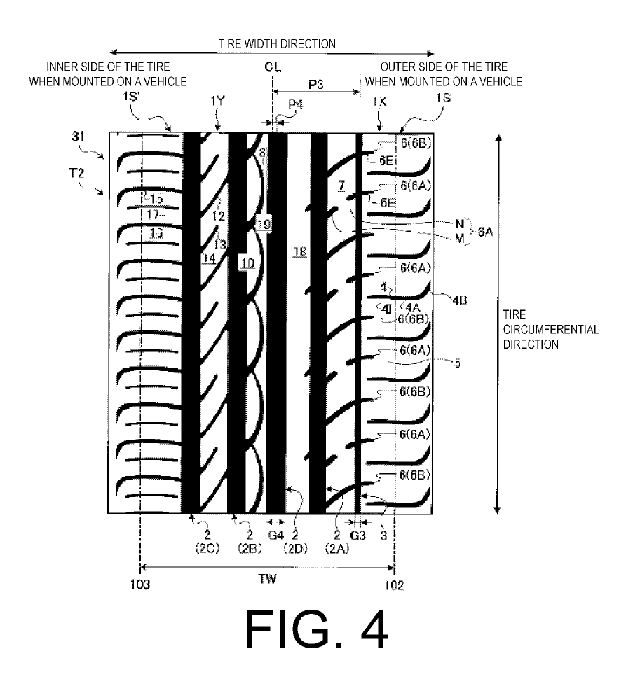

FIG. 4 is a plan view illustrating a tread surface of a pneumatic tire of embodiment 2. Only the differences from the example illustrated in FIG. 1 (Embodiment 1) will be described for the example illustrated in FIG. 4 (Embodiment 2). Note that in FIG. 4, those constituents that have the same reference numerals as in FIG. 1 are identical to the constituents illustrated in FIG. 1.

In the pneumatic tire T2 illustrated in FIG. 4, four circumferential main grooves 2 extending linearly in the tire circumferential direction are provided in a tread surface 31. The tread surface 31 includes an outer side region 1X positioned outward of the tire ground contact center line CL when the tire is mounted, and an inner side region 1Y positioned inward of the tire ground contact center line CL when the tire is mounted.

With a pneumatic tire T2 illustrated in FIG. 4, compared with the pneumatic tire T1 illustrated in FIG. 1, the grooves provided on the inner side of the tire when mounted on a vehicle inward of the sub grooves 8 in the inner side region 1Y are provided more to the inner side of the tire when mounted on a vehicle, and the grooves provided on the outer side of the tire when mounted on a vehicle outward of the first circumferential main groove 2A in the outer side region 1X are provided more to the outer side of the tire when mounted on a vehicle. In embodiment 2, a fourth circumferential main groove 2D is newly provided in a region, formed by the configuration of the grooves described above, between the sub grooves 8 and the first circumferential main groove 2A, so as to include the tire ground contact center line CL. A rib 18 is formed between the first circumferential main groove 2A and the fourth circumferential main groove 2D, and a rib 19 is formed between the fourth circumferential main groove 2D and the sub grooves 8.

Based on such a structure, the pneumatic tire T2 of this embodiment is configured as described below. First, the tread surface 31 has an asymmetrical pattern demarcated by the tire ground contact center line CL, wherein groove area ratios in a first side in a tire width direction and a second side in the tire width direction vary in a range of not less than 5% and not more than 15%. The example illustrated in FIG. 4 is an asymmetrical pattern wherein the groove area ratio of the outer side of the tire when mounted on a vehicle is 6% less compared to that of the inner side of the tire when mounted on a vehicle.

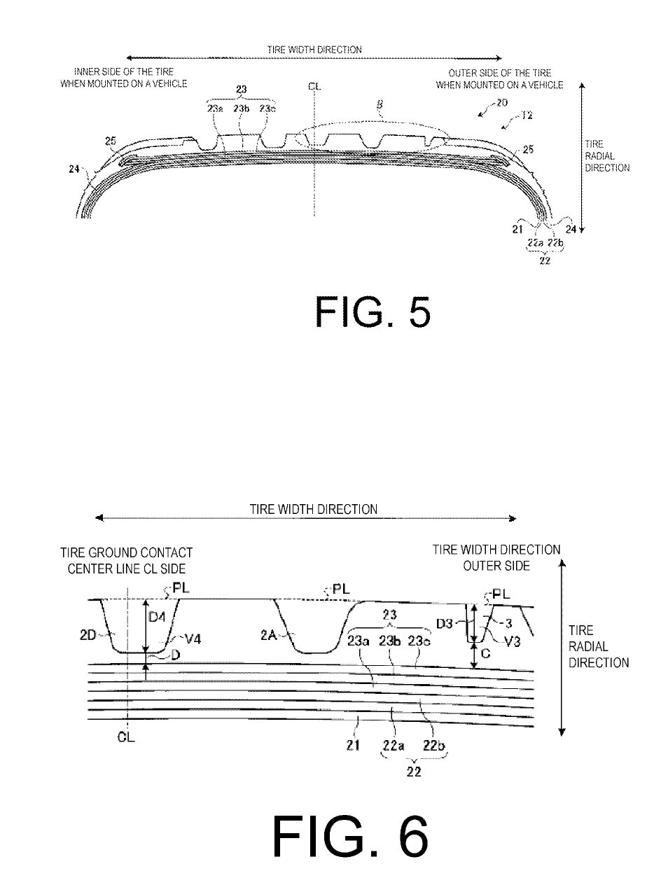

FIG. 5 is a meridian cross-sectional view illustrating a tread portion of the pneumatic tire T2 of embodiment 2. FIG. 6 is a meridian cross-sectional view illustrating an enlargement of a region B depicted in FIG. 5. As illustrated in FIG. 6, in a tread surface 31 of the pneumatic tire T2 of embodiment 2, two fourth circumferential main grooves 2D and one circumferential main groove 2A, and one circumferential narrow groove 3 positioned on the outer side in the tire width direction of the first circumferential main groove 2A are formed in the side from the tire ground contact center line CL having the smaller groove area ratio (the outer side of the tire when mounted on a vehicle). Additionally, a depth D3 of the circumferential narrow groove 3 is configured to be not less than 60% and not more than 80% of a depth D4 of the fourth circumferential main groove 2D positioned on the tire ground contact center line CL.

Additionally, as illustrated in FIG. 4, with the pneumatic tire T2 of embodiment 2, a width G3 of the circumferential narrow groove 3 is configured so as to be not less than 25% and not more than 40% of a width G4 of the fourth circumferential main groove 2D positioned on the tire ground contact center line.

Additionally, with the pneumatic tire T2 of embodiment 2, a distance P3 from the tire ground contact center line CL to the center position in the tire width direction of the circumferential narrow groove 3 is configured to be not less than 25% and not more than 35% of a tire ground contact width TW.

Thus, the pneumatic tire T2 of embodiment 2 is formed the same as the pneumatic tire T1 of embodiment 1 by appropriately configuring the asymmetrical pattern demarcated by the tire ground contact center line CL, the depth and the width of the specific circumferential narrow groove 3 with respect to the depth and the width of the specific fourth circumferential main groove 2D, and the position of the circumferential narrow groove 3 with respect to the tire ground contact center line CL. With such a configuration, steering stability on dry road surfaces can be particularly enhanced while sufficient water removal performance is ensured and a decline in steering stability on wet road surfaces is suppressed. Additionally, according to the pneumatic tire T2 of embodiment 2, rigidity of the land portions of the tread surface can be sufficiently ensured and notching of the land portion edges and abnormal wear of the land portions can be suppressed. However, this does not lead to only steering stability on dry road surfaces being enhanced, but also to the enhancing of the durability of the pneumatic tire T2.

As illustrated in FIG. 6, with the pneumatic tire T2 of this embodiment, a tread gauge C on the inner side in the tire radial direction of the circumferential narrow groove 3 is preferably not less than 1.3 times and not more than 2.6 times greater than a tread gauge D on the inner side in the tire radial direction of the fourth circumferential main groove 2D positioned on the tire ground contact center line CL. As a result, ground contact pressure from the fourth circumferential main groove 2D to the circumferential narrow groove 3 can be made constant, notching of the land portion edges and abnormal wear of the land portions can be efficiently suppressed, and steering stability on dry road surfaces can be efficiently enhanced.

Additionally, as illustrated in FIG. 4, with the pneumatic tire T2 of this embodiment, regarding the fourth circumferential main groove 2D, a distance P4 from the tire ground contact center line CL to the center position of the fourth circumferential main groove 2D is preferably not less than 10% and not more than 20% of the tire ground contact width TW. As a result, optimum rigidity of the land portion that includes the tire ground contact center line can be sufficiently ensured and steering stability on dry road surfaces under high severity conditions can be ensured; and, moreover, steering stability on dry road surfaces under high severity conditions can be further enhanced.

Additionally by configuring the distance P4 from the tire ground contact center line CL to the center position of the specific fourth circumferential main groove 2D to be not less than 10% and not more than 20% of the tire ground contact width TW, this configuration will work in concert with the range setting of the distance P3 from the tire ground contact center line CL to the center position of the circumferential narrow groove 3 described above. Therefore, an optimum block 7 adjacent to the circumferential narrow groove 3 on the inner side in the tire width direction that meets the tire nominal width and desired tire performance can be obtained. As a result, notching of the land portion edges and abnormal wear of the land portions can be further suppressed, and steering stability on dry road surfaces can be further enhanced.

Additionally, as illustrated in FIG. 6, with the pneumatic tire T2 of this embodiment, a smallest cross-sectional area V3 of the circumferential narrow groove 3 is preferably not less than 20% and not more than 30% of a smallest cross-sectional area V4 of the fourth circumferential main groove 2D positioned on the tire ground contact center line CL. As a result, water removal performance can be further ensured, a decline in steering stability on wet road surfaces can be further suppressed, notching of the land portion edges and abnormal wear of the land portions can be further suppressed, and steering stability on dry road surfaces can be further enhanced.

Additionally, with the pneumatic tire T2 of this embodiment, a JIS A hardness of a rubber material constituting the tread portion on the side from the tire ground contact center line CL having the smaller groove area ratio is preferably not less than 71 and not more than 77. As a result, the amount of deformation of the tread portion is suppressed, particularly, suppression of the decline in the steering stability on wet road surfaces and enhancement of the steering stability on dry road surfaces can be sufficiently realized, and both steering stability and riding comfort can be obtained.

Additionally, with the pneumatic tire T2 of this embodiment, the tire nominal width (defined by JATMA) is preferably not less than 265. As the tire nominal width increases, the width G4 of the fourth circumferential main groove 2D and the width G3 of the circumferential narrow groove 3 also increase. By configuring the tire nominal width to be not less than 265, particularly, suppression of the decline in the steering stability on wet road surfaces and enhancement of the steering stability on dry road surfaces can be sufficiently realized.

### EXAMPLES

Pneumatic tires according to the embodiments, conventional example, and comparative examples were manufactured and evaluated. Note that the pneumatic tires according to the embodiments are working examples. The comparative examples are not the same as the conventional example.

### Working Example Group 1

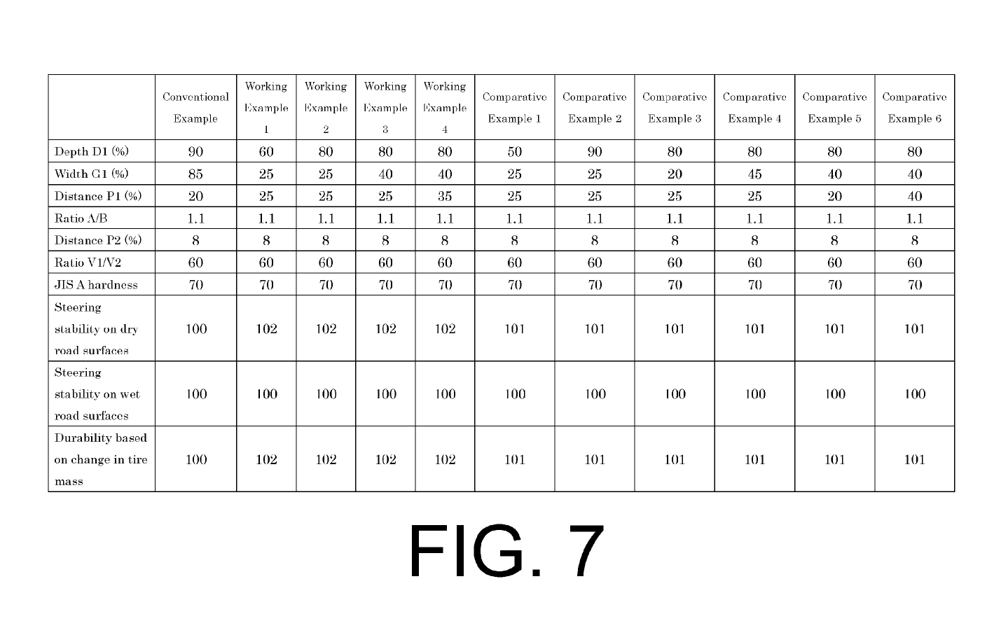

Pneumatic tires for each of the Conventional Example, Comparative Examples 1 to 6, and Working Examples 1 to 6 were manufactured as follows. Each pneumatic tire was provided with a common tire size of 275/45R20 110Y and the configuration illustrated in FIGS. 1 to 3. The groove area ratio on the outer side of the tire when mounted on a vehicle was configured to be 10% smaller than the groove area ratio on the inner side of the tire when mounted on a vehicle. The depth D1 of the circumferential narrow groove, the width G1 of the circumferential narrow groove, and the distance P1 from the tire ground contact center line to the center position in the tire width direction of the circumferential narrow groove were varied as shown in FIG. 7. Note that the depth D2 of the circumferential main groove was 8.5 mm, the width G2 of the circumferential main groove was 18 mm, and the tire ground contact width was 220 mm. Additionally, a ratio A/B of the tread gauge on the inner side in the tire radial direction of the circumferential narrow groove to the tread gauge on the inner side in the tire radial direction of the circumferential main groove closest to the tire ground contact center line, the distance P2 from the tire ground contact center line to the center position in the tire width direction of the circumferential main groove, a ratio V1/V2 of the smallest cross-sectional area of the circumferential narrow groove to the smallest cross-sectional area of the circumferential main groove closest to the tire ground contact center line, and the JIS A hardness of the rubber material of the tread portion on the side from the tire ground contact center line having the smaller groove area ratio of the test tires were configured to be identical as shown in FIG. 7.

The test tires were assembled on a rim having a rim size of 20×9J. The front wheels were inflated to an air pressure of 260 kPa and the rear wheels to 290 kPa. Then evaluations of steering stability on dry road surfaces, steering stability on wet road surfaces, and durability based on a change in tire mass were performed. A foreign-built, 3.2 L sedan was used as the vehicle in the testing.

For the steering stability on dry road surfaces tests, sensory evaluations were conducted by test drivers and the evaluation scores were indexed. Also, for the steering stability on wet road surfaces tests, sensory evaluations were conducted by test drivers and the evaluation scores were indexed. Furthermore, for the durability test based on the change in tire mass, the amount of change in tire mass was measured after running the tire on a dry road surface for 200 km. This change in mass was also indexed. Results of these tests are shown in FIG. 7. Note that in all cases, larger index values indicate superior results.

As is clear from FIG. 7, the results for the steering stability on dry road surfaces tests and the durability tests based on the amount of change of tire mass were superior for each of the pneumatic tires that were within the scope of the present technology (Working Examples 1 to 4) where the depth D1 was not less than 60% and not more than 80%, the width G1 was not less than 25% and not more than 40%, and the distance P1 was not less than 25% and not more than 35%, compared to the pneumatic tire of the Conventional Example, which was outside the scope of the present technology. It is thought that steering stability on dry road surfaces and durability can be enhanced as a result of the rigidity of the land portions positioned on both sides of the circumferential narrow groove in the tire width direction being sufficiently ensured while sufficient water removal performance is sufficiently ensured and a decline in steering stability on wet road surfaces is suppressed by configuring the depth D1, the width G1, and the distance P1 described above to be within preferable ranges.

In contrast, with the pneumatic tires of Comparative Examples 1 to 6, the depth D1, the width G1, and the distance P1 were each configured to be outside the preferable ranges. Therefore, compared to the pneumatic tires of Working Examples 1 to 4, superior results for each criterion were not obtained.

### Working Example Group 2

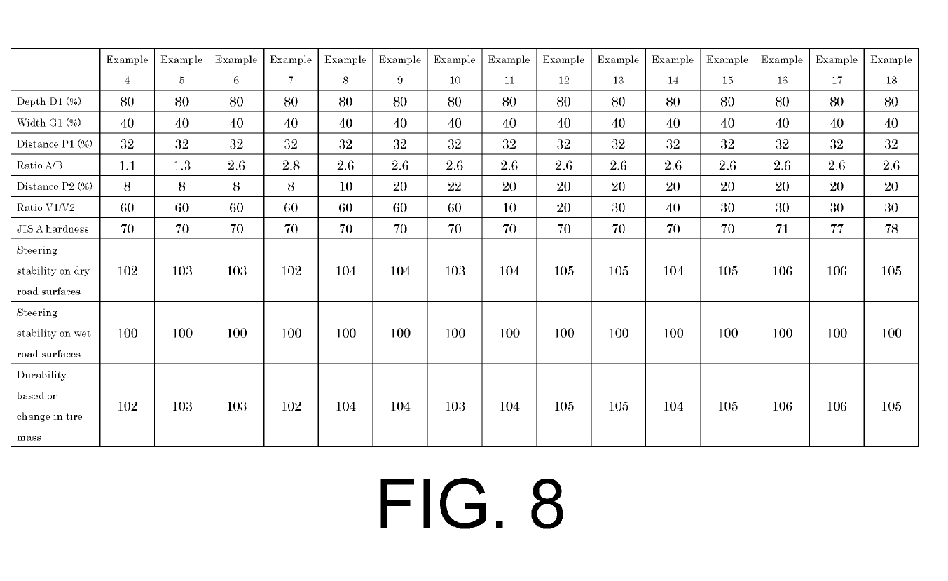

Pneumatic tires for each of Working Examples 4 to 18 were manufactured as follows. Each pneumatic tire was provided with a common tire size of 275/45R20 110Y and the configuration illustrated in FIGS. 1 to 3. The groove area ratio on the outer side of the tire when mounted on a vehicle was configured to be 10% smaller than the groove area ratio on the inner side of the tire when mounted on a vehicle. A ratio A/B of the tread gauge on the inner side in the tire radial direction of the circumferential narrow groove to the tread gauge on the inner side in the tire radial direction of the circumferential main groove closest to the tire ground contact center line, the distance P2 from the tire ground contact center line to the center position in the tire width direction of the circumferential main groove, a ratio V1/V2 of the smallest cross-sectional area of the circumferential narrow groove to the smallest cross-sectional area of the circumferential main groove closest to the tire ground contact center line, and the JIS A hardness of the rubber material of the tread portion on the side from the tire ground contact center line having the smaller groove area ratio of the test tires were varied as shown in FIG. 8. Additionally, in the test tires, the depth D1 of the circumferential narrow groove, the width G1 of the circumferential narrow groove, and the distance P1 from the tire ground contact center line to the center position in the tire width direction of the circumferential narrow groove were configured to be identical as shown in FIG. 8. Note that the depth D2 of the circumferential main groove was 8.5 mm, the width G2 of the circumferential main groove was 18 mm, and the tire ground contact width was 220 mm.

The test tires were subjected to evaluations of steering stability on dry road surfaces, steering stability on wet road surfaces, and durability based on a change in tire mass, the same as for Working Example Group 1. Results of these tests are shown in FIG. 8. Note that in all cases, larger index values indicate superior results.

As is clear from FIG. 8, of the pneumatic tires having the depth D1, the width G1, and the distance P1 within the scope of the present technology (Working Examples 4 to 18), the pneumatic tires of Working Examples 5 and 6, where the ratio A/B was within the preferable range (not less than 1.3 and not more than 2.6) obtained superior results in the steering stability on dry road surfaces tests and the durability tests based on the change of tire mass, compared to Working Examples 4 and 7, where the ratio A/B was outside the preferable range. It is thought that this is a result of the ground contact pressure from the circumferential main groove closest to the tire ground contact center line to the circumferential narrow groove being made constant, therefore leading to notching of the land portion edges and abnormal wear of the land portions being efficiently suppressed, and also to steering stability on dry road surfaces being efficiently enhanced.

Additionally, the pneumatic tires of Working Examples 8 and 9, where the distance P2 was configured to be within the preferable range (not less than 10% and not more than 20% of the tire ground contact width TW) obtained superior results in the steering stability on dry road surfaces tests and the durability tests based on the change of tire mass, compared to Working Examples 6 and 10, where the distance P2 was outside the preferable range. It is thought that this is a result of this configuration working in concert with the distance from the tire ground contact center line to the center position of the circumferential narrow groove being in the given range, leading to the rigidity of the land portion adjacent to the circumferential narrow groove on the inner side in the tire width direction being further ensured and steering stability on dry road surfaces under high severity conditions being further enhanced.

Additionally, the pneumatic tires of Working Examples 12 and 13, where the ratio V1/V2 was configured to be within the preferable range (not less than 20% and not more than 30%) obtained superior results in the steering stability on dry road surfaces tests and the durability tests based on the change of tire mass, compared to Working Examples 11 and 14, where the ratio V1/V2 was outside the preferable range. It is thought that this is a result of the rigidity of the land portions positioned on both sides of the circumferential narrow groove in the tire width direction being further ensured, the notching of the land portion edges and abnormal wear of the land portions being efficiently suppressed, and the steering stability on dry road surfaces being further enhanced.

Additionally, the pneumatic tires of Working Examples 16 and 17, where the JIS A hardness was configured to be within the preferable range (from 71 to 77) obtained superior results in the steering stability on dry road surfaces tests and the durability tests based on the change of tire mass, compared to Working Examples 15 and 18, where the JIS A hardness was outside the preferable range. It is thought that this is a result of the amount of deformation of the tread being suppressed, which leads to various effects due to the stipulating of the positions and the depths of the circumferential narrow groove and the circumferential main groove, particularly being able to sufficiently realize an enhancement in the steering stability on dry road surfaces.

As described above, the pneumatic tire of the present technology is useful in enhancing steering stability on dry road surfaces and enhancing durability while suppressing a decline in steering stability on wet road surfaces.

What is claimed is:

1. A pneumatic tire comprising an asymmetrical pattern wherein groove area ratios with respect to a tread ground contact area in a first side in a tire width direction and in a second side in the tire width direction, demarcated by a tire ground contact center line, vary in a range of not less than 5% and not more than 15%, wherein
the side from the tire ground contact center line having a smaller groove area ratio comprises at least one circumferential main groove and at least one circumferential narrow groove that is positioned on an outer side in the tire width direction of the circumferential main groove;
a depth of the circumferential narrow groove is not less than 60% and not more than 80% of a depth of the circumferential main groove closest to the tire ground contact center line;
a width of the circumferential narrow groove is not less than 25% and not more than 40% of a width of the circumferential main groove closest to the tire ground contact center line; and
a distance from the tire ground contact center line to a center position in the tire width direction of the circumferential narrow groove is not less than 25% and not more than 35% of a tire ground contact width.

2. The pneumatic tire according to claim 1, wherein one circumferential main groove is provided and one circumferential narrow groove is provided.

3. The pneumatic tire according to claim 1, wherein a tread gauge on an inner side in a tire radial direction of the circumferential narrow groove is not less than 1.3 times and not more than 2.6 times greater than a tread gauge on the inner side in the tire radial direction of the circumferential main groove closest to the tire ground contact center line, or a tread gauge on the inner side in the tire radial direction of the circumferential main groove positioned on the tire ground contact center line.

4. The pneumatic tire according to claim 1, wherein the circumferential main groove having a center position in the tire width direction on the side from the tire ground contact center line with the smaller groove area ratio has a distance from the tire ground contact center line to the center position of the circumferential main groove that is not less than 10% and not more than 20% of the tire ground contact width.

5. The pneumatic tire according to claim 1, wherein a smallest cross-sectional area of the circumferential narrow groove is not less than 20% and not more than 30% of a smallest cross-sectional area of the circumferential main groove closest to the tire ground contact center line or a smallest cross-sectional area of the circumferential main groove positioned on the tire ground contact center line.

6. The pneumatic tire according to claim 1, wherein a JIS A hardness of a rubber material constituting a tread portion on the side from the tire ground contact center line having the smaller groove area ratio is not less than 71 and not more than 77.

7. The pneumatic tire according to claim 1, wherein a tire nominal width, defined by the Japan Automobile Tyre Manufacturers Association Inc., is not less than 265.

8. The pneumatic tire according to claim 1, further comprising a first lateral groove separated from the circumferential narrow groove so as not to be in communication, and a land portion farther toward the outer side in the tire width direction than the circumferential narrow groove is formed into a rib that is continuous in the tire circumferential direction, the first lateral groove having an “S” shape structure in which a first arcuate groove portion, which is convex toward a first side in the tire circumferential direction, and a second arcuate groove portion, which is convex toward a second side in the tire circumferential direction are contiguously connected.

9. The pneumatic tire according to claim 8, further comprising a second lateral groove extending beyond the circumferential narrow groove from the circumferential main groove toward the outer side in the tire width direction is disposed with a predetermined spacing in the tire circumferential direction, the second lateral groove extending inclined with respect to the tire width direction and disposed offset in the tire circumferential direction with respect to the first lateral groove so that a portion extending beyond the circumferential narrow groove does not intersect with the first lateral groove; and wherein an outer side end of the second lateral groove extends so as to overlap with an inner side end of the first lateral groove when viewed in the tire circumferential direction.

10. The pneumatic tire according to claim 8, wherein a second lateral groove disposed alternately in the tire circumferential direction is constituted by a first lateral groove portion that extends from the circumferential main groove to a portion partway between the circumferential narrow groove and the circumferential main groove, and a second lateral groove portion that extends from a position separated from the first lateral groove portion to beyond the circumferential narrow groove; and wherein another alternately disposed second lateral groove extends from the circumferential main groove to a position beyond the circumferential narrow groove such that a block is formed, partitioned by adjacent second lateral grooves, between the circumferential main groove and the circumferential narrow groove.

11. The pneumatic tire according to claim 10, wherein the at least one circumferential main groove comprises a first circumferential main groove and the second circumferential main groove, the pneumatic tire further comprising a plurality of sub grooves, extending in an arcuate manner in the tire circumferential direction from the second circumferential main groove to beyond the tire ground contact center line and disposed so that a portion thereof overlaps.

12. The pneumatic tire according to claim 11, further comprising: a third lateral groove extending inclined with respect to the tire width direction and communicating with the first and second circumferential main grooves; and a fourth lateral groove extending inclined with respect to the tire width direction from a third circumferential main groove to a portion partway through a block; wherein the third and fourth lateral grooves are alternately disposed with a predetermined spacing in the tire circumferential direction between the second circumferential main groove and the third circumferential main groove of an inner side region; and the block is partitioned and formed by the third lateral groove and the second and third circumferential main grooves.

13. The pneumatic tire according to claim 12, further comprising: a fifth lateral groove, extending from the third circumferential main groove to beyond a second tire ground contact edge toward the outer side in the tire width direction, the fifth lateral groove being disposed with a predetermined spacing in the tire circumferential direction in a shoulder region of the inner side region that is outward of the third circumferential main groove in the tire width direction; and a block, partitioned and formed by the third circumferential main groove and the fifth lateral groove.

14. The pneumatic tire according to claim 1, wherein the depth of the circumferential narrow groove is not less than 65% and not more than 75% of a depth of the circumferential main groove closest to the tire ground contact center line.

15. A pneumatic tire comprising an asymmetrical pattern wherein groove area ratios with respect to a tread ground contact area in a first side in a tire width direction and in a second side in the tire width direction, demarcated by a tire ground contact center line, vary in a range of not less than 5% and not more than 15%, wherein
the side from the tire ground contact center line having a smaller groove area ratio comprises at least one circumferential main groove and at least one circumferential narrow groove that is positioned on an outer side in the tire width direction of the circumferential main groove;
a depth of the circumferential narrow groove is not less than 60% and not more than 80% of a depth of the circumferential main groove positioned on the tire ground contact center line;
a width of the circumferential narrow groove is not less than 25% and not more than 40% of a width of the circumferential main groove positioned on the tire ground contact center line; and
a distance from the tire ground contact center line to a center position in the tire width direction of the circumferential narrow groove is not less than 25% and not more than 35% of a tire ground contact width.

16. The pneumatic tire according to claim 15, wherein a tread gauge on an inner side in a tire radial direction of the circumferential narrow groove is not less than 1.3 times and not more than 2.6 times greater than a tread gauge on the inner side in the tire radial direction of the circumferential main groove closest to the tire ground contact center line, or a tread gauge on the inner side in the tire radial direction of the circumferential main groove positioned on the tire ground contact center line.

17. The pneumatic tire according to claim 15, wherein the circumferential main groove having a center position in the tire width direction on the side from the tire ground contact center line with the smaller groove area ratio has a distance from the tire ground contact center line to the center position of the circumferential main groove that is not less than 10% and not more than 20% of the tire ground contact width.

18. The pneumatic tire according to claim 15, wherein a smallest cross-sectional area of the circumferential narrow groove is not less than 20% and not more than 30% of a smallest cross-sectional area of the circumferential main groove closest to the tire ground contact center line or a smallest cross-sectional area of the circumferential main groove positioned on the tire ground contact center line.

19. The pneumatic tire according to claim 15, wherein a JIS A hardness of a rubber material constituting a tread portion on the side from the tire ground contact center line having the smaller groove area ratio is not less than 71 and not more than 77.

20. The pneumatic tire according to claim 15, wherein a tire nominal width, defined by the Japan Automobile Tyre Manufacturers Association Inc., is not less than 265.
